(19) United States
(12) Patent Application Publication
(10) Pub. No.: US 2026/0017617 A1
(43) Pub. Date: Jan. 15, 2026

(54) Future Leader Development Process

(71) Applicant: William J. Endres, Houghton, MI (US)

(72) Inventor: William J. Endres, Houghton, MI (US)

(73) Assignee: Evolvent Leader Development, LLC, Houghton, MI (US)

(21) Appl. No.: 18/773,520

(22) Filed: Jul. 15, 2024

(51) Int. Cl. G06Q 10/109; G06Q 10/0631

(52) U.S. Cl. CPC G06Q 10/109; G06Q 10/06311

(57) ABSTRACT

This invention involves a method for enhancing knowledge of leadership in individuals by way of them being participants, multiple lesser-experienced peers along with a greater-experienced guide, in a small-group learning experience over one or more available seasons of study. Each season of study comprises a sequence of meetings totaling at least two. The structure of the method aims to provide an experience that entices a significant percentage of the participants in a current season of study to commit to continuing their participation in the next available season of study. One embodiment of this invention includes various communications that comprise messages that deliver assigned content and prompts for reflection for the purpose of preparing the participants for the discussion held during the subsequent meeting. Another embodiment of this invention also includes assessments of peer participants' preparation for the meetings. Various embodiments include various methods and formats for the messages and meetings.

### BACKGROUND OF THE INVENTION

Leadership practice is important. Sound and true leading is first and foremost a matter of mindset-how you think, not what you think. Mindset, and the knowledge that feeds it, does not develop in a one-and-done class and an occasional workshop. It evolves over a lifetime. But like anything that evolves, it starts with those vital first steps and continues only through regular study and implementation over the timeframe of years, not days or months.

In spite of the importance of leadership, many find themselves in a formal leadership position or role either not having a solid foundation of sound and true knowledge and skills, or thinking they know what leadership is but only knowing the “buzzword” version. Most leadership-related services at present serve the here-and-now of executive coaching and middle-management development, focusing on tools and one-on-one coaching. Services that reach people before they are in a formal leadership position or role are scarce.

In learning the underlying principles and practical implementation by way of others' experiences, a gradual and continual process is advantageous. Though means such as seminars and workshops allow engagement of large audiences making them generally low-resource, low-cost approaches, their effectiveness is also lesser than more continual engagement over time. In particular, when it comes to mindset development, attending a seminar or workshop now and then is not effective for many individuals in regard to changing how they think. On the other end of the spectrum of scale is one-on-one coaching. Because of its resource intensiveness, it is directed to people who are already in high-responsibility leadership roles. It is for this reason-resource intensiveness, high perceived value, and with that generally high profitability—that a significant focus of the modern leader development industry is one-on-one coaching at the middle-management and executive level.

Starting the growth of a leader's mindset early on in an individual's adulthood, in a way that maximizes effectiveness relative to the resources expended, requires a process that is scalable and, simultaneously, repeatable at scale. Like in manufacturing, both scalability and repeatability are well supported by processes that are structured and even automated. But with people as the raw material, the process of enhancing factual and experiential knowledge of leadership in individuals must be applied in a way that does not rely on a disconnected seminar-scale audience, whether interactive or not.

Based on the above analysis on the leadership development industry, the method claimed in the present invention aims to grow leadership knowledge, skills, and mindset in a market segment not well addressed—individuals prior to their first formal professional leadership role—in a way that is gradual and engaging via multiple meetings of small groups, not large occasional seminars nor costly one-on-one coaching that is aimed at mid- and high-level managers and executives. In general, the method claimed in the present invention blends the model of executive peer groups with well-established approaches to transformational, deep-rooted learning that involve discussion and reflection. Based on assigned content across a series of synchronously attended meetings, participants work in small groups made up of multiple peers, or lesser-experienced individuals (LEIs), and at least one seasoned guide, or greater-experienced individual (GEI). A GEI is an individual having held for a duration of time one or more formal leadership positions or roles in a professional capacity, such as but not limited to positions bearing titles such as but not limited to Chief Executive Officer, Chief Operations Officer, President, Vice President, Director, Department Head, College Dean, Head Coach, Assistant Coach, Manager, and various higher military ranks. An LEI is an individual with lesser experience in leading compared to the GEI, generally substantively lesser experience, usually but not necessarily having no formal professional experience in a leadership role. The meetings take place over a span of time referred to as a season of study, while an LEI may have the potential for continuing participation over a longer duration of time by participating in multiple seasons of study, which are generally but not necessarily sequential.

The method claimed in the present invention aims to realize measurable, business-sustaining outcomes by way of (1) preparing participants for their meetings, (2) enabling productive meetings, and (3) enabling profitably efficient scalability. Item (3) is realized by way of back-end software implementation of the method claimed in the present invention, the software operating either autonomously, through manual human interaction, or in some combination of both, all such implementation being made possible by the method's operational structure being designed to yield consistent yet flexible intra-period operations within a definable meeting-to-meeting and season-to-season periodicity. Items (1) and (2) are realized by the front-end interaction of the claimed method since it is founded on well-established learning approaches. Taken together, the method ultimately results in leadership growth and participant value, as evidenced by way of participants continuing from one season of study to the next available season of study, that continuation being a business-sustaining outcome in the form of customer retention, which serves to enhance the return on investment made in the form of customer acquisition for the first season of study. Quantifying the effectiveness of the method claimed in the present invention involves assessing preparation of the participants for their meetings noted in item (2) and assessing participant value, largely connected to item (1), as measured in participant continuation across successive seasons of study within the claimed method.

In regard to participants continuing across successive seasons of study, this equates to the more general measure of return or repeat customers, or customer retention rate. According to Geckoboard, which offers visualization of key performance indicators (KPI) like repeat customer rate, “Ultimately your Repeat Customer Rate will depend a lot on your business's industry.” Toward determining a target continuation rate, we must determine the industry or industries in which the method operates, or the field of the invention. The field of the invention, from the perspective of the operational means within the method claimed, as opposed to a content and market-offering perspective being leadership development, as described earlier, is educational technology, or “ed-tech,” and, by way of the means of its offering in some embodiments, e-commerce.

Regarding ed-tech, an AI response to a Google search query “what is ed tech” states that “Edtech, or educational technology, is the use of technology to enhance the learning experience for students and educators. It can include hardware, software, and other related items, such as: educational apps and games, podcasts, learning management systems (LMS), video conferencing software, and online discussion forums.” Specifically, the present invention is a business method that employs discussion which, in some embodiments, occurs by way of online interaction by way of video conferencing software, while the front-end is supported by the overall operation of the back-end via software implementation, as well as are the inter-meeting messages in some embodiments.

Geckoboard continued the earlier quote with (bracketed connections to the present invention added here): “The biggest factor for repeat customers depends on the type, and range of products [or services] you sell. An online store that sells cheaper expendable products [or cheaper services with shorter-term effect] should have a higher percentage of repeat customers than one selling expensive goods with a longer lifespan [or expensive services with longer-term effect].” The service supported by and embodied within the method claimed in the present invention can carry on for multiple years in its present envisioned conceptual implementation and initial testing, meaning it is long-term in its duration and, by design, “longer-term [in its] effect.” Further, it is designed to profitably support a targeted price point that, while being an “expensive service” compared to books and typical seminars that have a relatively “shorter-term effect,” is competitively lesser cost than one-on-one executive and middle-management coaching. In other words, the service supported by and embodied within the method claimed in the present invention would not be considered “cheaper or expendable.” That same source notes the following in regard to e-commerce: “Although benchmarks vary from company to company, most e-commerce businesses have 25-30% percent returning customers. This is backed up by Alex Schultz, VP of Growth at Facebook who says, ‘If you can get 20-30% of customers coming back every month and making a purchase from your store, you should do pretty well.’” In the case of the method claimed in the present invention, customers would be “coming back every [season] and making a purchase.”

Moengage, a company that offers a customer engagement platform, provides a breakdown of customer retention rate across industries, showing ed-tech to come in at 27% and e-commerce at 38%. The method claimed in the present invention, in some embodiments, fits well into their description of ed-tech: “Technology has provided a greater platform for the education system and broadened the horizon to gain an education. This industry has gained immense popularity because of the upsurge in online classes due to the pandemic. Some ed-tech companies such as Coursera, INC, UDEMY, MasterClass are successfully catering to the demand for online education and courses.” Finally, initial testing of the method has produced peer continuation data, from the first season of study to the second season of study, of 47.5% (19 of 40 season-one peers).

### SUMMARY OF THE INVENTION

Most leadership development is focused on regular small-scale coaching of established managers and executives, or large-scale information transfer through occasional workshops and seminars. The present invention is a method to provide, at scale yet in small groups, a structured environment and content for leadership development. The method blends the model of executive peer-groups with well-established approaches to transformational, deep-rooted learning. Groups of participants include two or more peers and at least one guide, who meet for two or more meetings over the course of a season of study. The objectives of the claimed method are to achieve a target percentage of peers who are prepared for their meetings and to achieve a target percentage of peers who choose to continue for a next available season of study upon completion of the current season of study.

### BRIEF DESCRIPTION OF DRAWINGS

FIG. 1 is a block diagram of one embodiment of the invention.

FIG. 2 is a block diagram of a second embodiment of the invention that includes assessment of peer preparation for meetings.

As required, detailed embodiments of the present invention are disclosed herein; however, it is to be understood that the disclosed embodiments are merely exemplary of the invention that may be embodied in various and alternative forms.

### DETAILED DESCRIPTION OF THE INVENTION

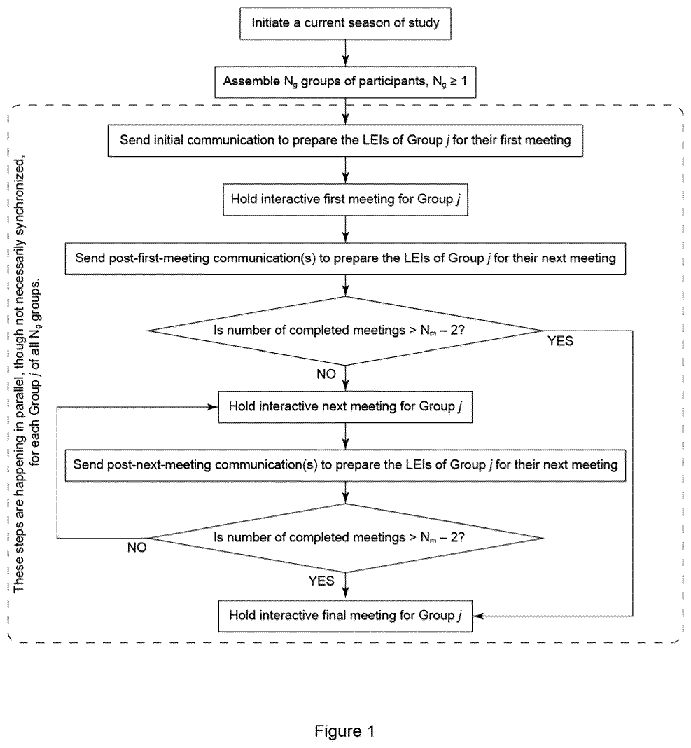

As shown in FIG. 1, the claimed method for enhancing knowledge of leadership in individuals commences by an administrator initiating a current season of study. The administrator is a human individual employed or contracted by the administrating organization. The administrating organization implements and operates the method on behalf of, and possibly along with individuals employed or contracted by, an offering organization that may or may not be the same as the administering organization.

A season of study is a sequence of at least two meetings, though typically more than two; the specific number of meetings in a season of study is Nₘ, or the meeting count. Meetings are scheduled such that under normal circumstances one meeting is present in each meeting period having duration equal to the meeting-to-meeting periodicity, Pₘ, which is, for example but without limitation, weekly, biweekly, or monthly. Nominally, meetings are scheduled on the same day of the week and time of day, but not necessarily. There is potential for any meeting to be rescheduled within that meeting's period, and there is potential for the insertion of one or more breaks within the current season of study, meaning there is no meeting held in those meeting periods for which a break has been inserted. As such, the duration of a current season of study having N_{b} breaks equals (Nₘ+N_{b})×Pₘ.

Initiating a current season of study includes extending an invitation to participate in the current season of study to lesser-experienced individuals (LEIs) and greater-experienced individuals (GEIs), each being referred to as an invited participant. The invitation to participate may be specifically extended to the invited participant by way of, as examples and without limitation, an email or a hard-copy letter or memo addressed specifically to that individual. Alternatively, the offer to participate may be generally extended to an invited participant by way of, as examples and without limitation, posting information about the current season of study on the administrating organization's website or the offering organization's website, mass email to a listserv, or advertisements in various media. The current season of study to which an LEI is invited is the next available season of study beyond the latest season of study the LEI may have previously completed. An acceptance of the invitation to participate is established by way of registration, another element of initiating the current season of study step. Registering of an individual includes the individual providing, or confirming or updating if this is not the individual's first season of study, the LEI's or GEI's personal information, including but not limited to name, email address, and availability. Upon an LEI's completion of registration, that LEI is referred to as a registered LEI or, more generally, as a registered participant. The next action for an LEI, within the step of initiating a current season of study, would be enrollment. Enrolling may include, without limitation, enrolling in a course with the offering organization according to how it defines enrolling in a course, paying a deposit, paying tuition, or any other means of formalizing an intention to participate. Upon an LEI's completion of enrollment, that LEI is referred to as a prospective LEI or, more generally, a prospective participant. Upon a GEI's completion of registration, each registered GEI, since generally but without limitation there is no need for a GEI to enroll, is advanced to the prospect level, being referred to as a prospective GEI or, more generally, a prospective participant.

The next step is assembling groups of participants. This happens after registration and requires availabilities, which are generally recorded during registration as part of the personal information of the registered LEIs and registered GEIs. At the discretion of the offering organization, an LEI may be acted upon within this step of the method either upon completion of registration, i.e., this step acting upon the registered LEIs, or upon completion of enrollment, i.e., this step acting upon the prospective LEIs. For simplicity, the following description of this step will be based on the latter, meaning the step is acting upon all enrolled or prospective LEIs, and together with the prospective GEIs, the prospective participants. In this step—assembling groups of participants—the administrator assembles N_{g} groups of participants, N_{g}≥1, for the current season of study. A group of participants comprises at least two LEIs, referred to as peers, and at least one GEI, referred to as the guide or guides. While a single guide is sufficient, more than one guide could be used, whether simultaneously present in the meetings or alternating their presence meeting to meeting in some fashion (randomly or periodically), if the cost of having more than one guide per group of participants is justified by the added value to the peers realized by having a plurality of guide perspectives. Each group of participants is assembled according to the overlap of the availabilities of the prospective participants. A prospective participant's availability is a collection of time ranges that the prospective participant has open in their schedule, or on their calendar, to participate in the synchronous meetings of their group of participants. Synchronous refers to the guide(s) and peers gathering at the same time and place, whether virtual or physical, and, more importantly, interacting in “real-time.” This is in contrast to asynchronous learning, which refers to students accessing materials at their own pace and interacting with each other over longer durations of time, typically not simultaneously or in “real time.” Once a prospective participant is assembled into a group of participants, that individual is referred to as an active participant, or simply a participant, being one of the two types—peer or guide, or LEI or GEI, respectively.

Continuing in reference to FIG. 1, the claimed method continues with sending an initial communication to the participants. The initial communication delivers a first-meeting message. The first-meeting message comprises at least an indication of the first-assigned content to be read, viewed, reviewed, listened to, and/or studied prior to it being addressed in the meeting discussion held at the first meeting. The first-meeting message generally also includes an indication of the day, time, and place, whether virtual or physical, for the first meeting as well as other welcoming and orientating content. The objective of the first-meeting message is to foster preparation of the LEIs for the meeting discussion to be held at the first meeting. The degree to which this objective is achieved by the method is quantitatively measured as the percentage of LEIs in a group of participants that have prepared themselves, or are prepared, to fully engage in the meeting discussion, the preparation percentage, held at the first meeting. Full engagement of an LEI in the first meeting is indicated by the LEI being able to, at minimum, pose to the group of participants one or more questions or thoughts specifically related to the first-assigned content, and provide at least one substantive response to each question or thought posed by each other peer.

Continuing in reference to FIG. 1, the claimed method continues by each of the N_{g} groups of participants of the current season of study interacting in the first meeting of the respective group of participants. Interaction at the first meeting means that the meeting discussion is held with a focus on the first-assigned content.

Continuing in reference to FIG. 1, the claimed method continues by sending at least one communication after the first meeting, each referred to as a post-first-meeting communication. The post-first-meeting communications cumulatively comprise a next-meeting message. The next-meeting message comprises at least an indication of the next-assigned content to be read, viewed, reviewed, listened to, and/or studied prior to it being addressed in the meeting discussion held at the next meeting. The next-meeting message may also include at least one prompt related to the meeting discussion held at the first meeting (or the immediately preceding meeting when this next meeting follows the second or higher-numbered meeting in the sequence). The objective of the next-meeting message is to foster preparation of the LEIs for the meeting discussion to be held at the next meeting. The degree to which this objective is achieved by the method is quantitatively measured as the percentage of LEIs in a group of participants that have prepared themselves, or are prepared, to fully engage in the meeting discussion, again referred to as the preparation percentage, held at the next meeting. Full engagement of an LEI in a next meeting is indicated by the LEI being able to, at minimum, pose to the group of participants one or more questions or thoughts specifically related to the next-assigned content, provide at least one substantive response to each question or thought posed by each other peer, and share a response to at least one prompt included in the next-meeting message.

Continuing in reference to FIG. 1, the claimed method continues by each of the N_{g} groups of participants of the current season of study interacting in a next meeting of the respective group of participants. Interaction at the next meeting means that the meeting discussion is held with a focus on the next-assigned content and responses to the prompt(s) related to the meeting discussion held at the first meeting (or the immediately preceding meeting when this next meeting follows the second or higher-numbered meeting in the sequence). Once the number of completed meetings exceeds Nₘ−2, this next meeting is referred to as a final meeting. For as long as the number of completed meetings is less than or equal to Nₘ−2, this next meeting is not the final meeting and is followed by sending at least one communication, each referred to as a post-next-meeting communication. The post-next-meeting communications cumulatively comprise a respective next-meeting message. This respective next-meeting message comprises, as described earlier, at least an indication of the next-assigned content to be read, viewed, reviewed, listened to, and/or studied prior to it being addressed in the meeting discussion held at the next meeting. This respective next-meeting message may also include at least one prompt related to the meeting discussion held at the preceding next meeting. The objective of this respective next-meeting message is the same as that described earlier in regard to preparing LEIs for the next meeting.

This next-meeting-post-next-meeting-communications structure is repeated until the number of completed meetings exceeds Nₘ−2, at which point the group of participants holds the final meeting as noted above. There are generally no post-final-meeting communications, though there could be such messaging with, for example and without limitation, at least one prompt related to the meeting discussion held at the final meeting, a thank-you message, and/or an invitation to continue to the next available season of study.

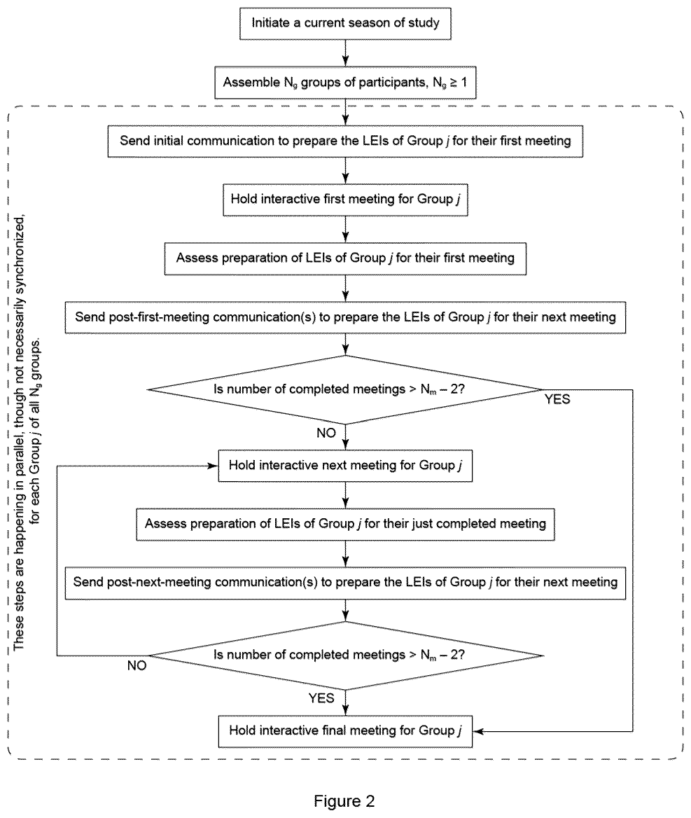

Meeting-to-meeting success of the method may be assessed by consistently achieving a target preparation percentage across all Nₘ meetings of the current season of study, and across all N_{g} groups of participants. A productive meeting discussion requires a minimum of two LEIs who have prepared themselves, or are prepared, such that they can be fully engaged in the meeting discussion, full engagement being as described earlier; it is for this reason that the method requires there to be at least two LEIs in a group of participants. While two LEIs are sufficient to form a group of participants as defined earlier, this requires each, or 100% of the LEIs, to be prepared for each meeting. Understanding that at times any individual LEI may have an unavoidable conflict that precludes their preparation, a realistic target preparation percentage must be lower than 100%. For these reasons, it is common, though not required, to have at least three LEIs in a group of participants. In this way, even if one of the three LEIs is unprepared, there are two LEIs who are prepared, or 67%, and with this a productive meeting discussion is enabled and the third, unprepared LEI will still benefit by his or her lesser than full engagement. Given this scenario, a reasonable target preparation percentage might be 66. This 66% target is further satisfied by three (75%) or more (>75%) out of four LEIs in a group of participants being prepared, four (80%) or more (>80%) out of five LEIs in a group of participants being prepared, four (67%) or more (>67%) out of six LEIs in a group of participants being prepared, and so forth. FIG. 2 shows where assessment steps may be introduced if either the administering organization or the offering organization desires to explicitly track and quantify meeting-to-meeting success.

The other metric of success, from a business standpoint, is the return customers as discussed in the background section. Specifically, here, this is referred to as the continuation percentage and is quantified as the percent of LEI participants across all N_{g} groups of participants deciding, at some point after the conclusion of the current season of study, to continue their participation in the next available season of study. Testing of the claimed method has revealed that, at times, an LEI participant in the current season of study may desire continuation, but must pause their participation due to schedule conflicts with work or personal life. For this reason, such assessment may be partially speculative at the conclusion of the current season of study being based on the intent of those LEIs at the conclusion of the current season of study. Based on the data in the background section, that from industry analysis (27%-38% customer return rate in ed-tech and e-commerce) and that from testing the method claimed in the present invention (47.5% of season-one LEIs), the method claimed in the present invention may reasonably have a target continuation percentage in the range of 35-50%.

When N_{g}>1, the multiple groups of participants in a current season of study follow the aforementioned steps, those that occur after assembling the groups of participants, in parallel, but not necessarily synchronized in terms of the calendar week of their respective first meeting, their respective final meeting, or any break or respective numbered meeting in the meeting sequence between the first and final meetings, across N_{g} groups of participants.

The initial communication, the post-first-meeting communication, each post-next-meeting communication, the final communication, and a post-final-meeting communication may be in any of, or in any combination of, the following forms and means of delivery: written paper or hard-copy form or in electronic form, electronic form including, as examples but without limitation, audio recording, video recording, or written form delivered by electronic means as an email or a text message by way of but not limited to short message service (SMS), multimedia messaging service (MMS), or similar means of electronic communication.

Any one or more of the first meeting, the next meetings, and the final meeting may be held by way of either internet-based (virtual) conferencing that involves two or more individuals of the group of participants, or physical collocation that involves two or more individuals of the group of participants, or some combination of the two modes (virtual and physical).

There may be more than one available season of study from which the current season of study is selected; multiple seasons of study are made available to an LEI in a generally but not necessarily predetermined sequence of seasons of study. When there is more than one available season of study there may be more than one current season of study running in parallel for any offering organization. There may be more than one offering organization served by the administering organization with the claimed method, though each offering organization need not be synchronized, in terms of the week in which the current season of study is initiated and/or the final meeting is held, with any other offering organization. The number of breaks can vary across groups of participants, current seasons of study, and offering organizations. While breaks usually imply no meeting of the group of participants for that meeting period, some breaks can include the group of participants holding a meeting for purposes other than those described above, such as but not limited to peers presenting to one another their cumulative thoughts on content from earlier in the current season of study or previous seasons of study, and their reports of attempts to apply content from earlier in the current season of study or previous seasons of study.

The back-end software implementation of the method claimed in the present invention, in support of scalability and efficiency, includes one or more functionalities that may be triggered either automatically by way of automation in the back-end software, or by way of manual intervention by the administrator or their designee interacting with the back-end software, or a combination of the two means of triggering. Those functionalities may include one or more of the following:
track the participation records or histories of LEIs and GEIs;
initiate a current season of study;
administer and process availability surveys in order to acquire the availability of each LEI and GEI as part of registration;
assemble groups of participants;
schedule meetings and breaks on the electronic calendars of participants either with or without notification to the participants;
modify meetings and/or breaks on the electronic calendars of participants either with or without notification to the participants;
deliver the initial communication, any next communication, and/or the final communication by way of electronic means;
update periodically, as needed (i.e., if a change in information occurs midstream in the current season of study), information present in any tools used by guides during meetings;
monitor at the meeting-to-meeting periodicity one or more of those functionalities that occur in each meeting period; and
administer and process LEI evaluation surveys in order to acquire feedback regarding one or more of the following without limitation: LEI value, guide performance, and desire-to-continue information.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method for enhancing knowledge of leadership in individuals by way of them being participants in a learning experience over one or more available seasons of study, each season of study comprising a sequence of meetings for a total of meeting count meetings such that meeting count is at least two, thereby enticing at least a target continuation percentage of the participants of a current season of study to commit to continue in a next available season of study, the method comprising the steps of:
a. initiating, by an administrator, the current season of study;
b. assembling, by the administrator, according to availabilities of prospective participants, at least one group of participants comprising:
i. two or more lesser-experienced individuals; and
ii. a greater-experienced individual;
c. sending an initial communication comprising a first-meeting message whereby at least a target preparation percentage of the lesser-experienced individuals are prepared for a meeting discussion to be held at a first meeting;
d. interacting, synchronously by each group of participants during the first meeting for the group of participants, in such a way that the meeting discussion is held by the group of participants in the first meeting for the group of participants;
e. sending at least one post-first-meeting communication, the post-first-meeting communications cumulatively comprising a next-meeting message whereby at least the target preparation percentage of the lesser-experienced individuals are prepared for the meeting discussion to be held at a next meeting;
f. performing step g through step h for a total number of times equal to the meeting count minus two;
g. interacting, synchronously by each group of participants during the next meeting for the group of participants, in such a way that the meeting discussion is held by the group of participants in the next meeting for the group of participants;
h. sending at least one post-next-meeting communication, the post-next-meeting communications cumulatively comprising the next-meeting message whereby at least the target preparation percentage of the lesser-experienced individuals are prepared for the meeting discussion to be held at the next meeting;
i. interacting, synchronously by each group of participants during a final meeting for the group of participants, in such a way that the meeting discussion is held by the group of participants in the final meeting for the group of participants; and
j. repeating step a through step i for all lesser-experienced individuals who are enticed by their participation in the current season of study to continue their participation in the next available season of study.

2. The method of claim 1, in which the target continuation percentage is 35.

3. The method of claim 1, in which the initial communication is in written electronic form.

4. The method of claim 1, in which the initial communication is in audio recording form.

5. The method of claim 1, in which the initial communication is in video recording form.

6. The method of claim 1, in which the initial communication is in written paper form.

7. The method of claim 1, in which the post-first-meeting communication is in written electronic form.

8. The method of claim 1, in which the post-first-meeting communication is in audio recording form.

9. The method of claim 1, in which the post-first-meeting communication is in video recording form.

10. The method of claim 1, in which at least one of the first meeting, the next meeting, and the final meeting is held by way of internet-based conferencing that involves two or more individuals of the group of participants.

11. The method of claim 1, in which at least one of the first meeting, the next meeting, and the final meeting is held by way of physical collocation that involves two or more individuals of the group of participants.

12. The method of claim 1, in which:
a. the first-meeting message comprises an indication of a first-assigned content; and
b. the meeting discussion held at the first meeting addresses the first-assigned content.

13. The method of claim 1, in which:
a. the next-meeting message cumulatively comprises:
i. an indication of a next-assigned content; and
ii. at least one prompt related to the meeting discussion held at the first meeting; and
b. the meeting discussion held at the next meeting addresses:
i. a response of each lesser-experienced individual to the prompt; and
ii. the next-assigned content.

14. The method of claim 1, in which the target preparation percentage is 66.

15. A method for enhancing knowledge of leadership in individuals by way of them being participants in a learning experience over one or more available seasons of study, each season of study comprising a sequence of meetings for a total of meeting count meetings such that meeting count is at least two, thereby enticing at least a target continuation percentage of the participants of a current season of study to commit to continue in a next available season of study, the method comprising the steps of:
a. initiating, by an administrator, the current season of study;
b. assembling, by the administrator, according to availabilities of prospective participants, at least one group of participants comprising:
i. two or more lesser-experienced individuals; and
ii. a greater-experienced individual;
c. sending an initial communication comprising a first-meeting message whereby at least a target preparation percentage of the lesser-experienced individuals are prepared for a meeting discussion to be held at a first meeting;
d. interacting, synchronously by each group of participants during the first meeting for the group of participants, in such a way that the meeting discussion is held by the group of participants in the first meeting for the group of participants;
e. assessing, by each greater-experienced individual, a preparation percentage for their respective group of participants for the completed first meeting;
f. sending at least one post-first-meeting communication, the post-first-meeting communications cumulatively comprising a next-meeting message whereby at least the target preparation percentage of the lesser-experienced individuals are prepared for the meeting discussion to be held at a next meeting;
g. repeating step h through step j for a total number of times equal to the meeting count minus two;
h. interacting, synchronously by each group of participants during the next meeting for the group of participants, in such a way that the meeting discussion is held by the group of participants in the next meeting for the group of participants;
i. assessing, by each greater-experienced individual, the preparation percentage for their respective group of participants for the just completed next meeting;
j. sending at least one post-next-meeting communication, the post-next-meeting communications cumulatively comprising the next-meeting message whereby at least the target preparation percentage of the lesser-experienced individuals are prepared for the meeting discussion to be held at the next meeting;
k. interacting, synchronously by each group of participants during a final meeting for the group of participants, in such a way that the meeting discussion is held by the group of participants in the final meeting for the group of participants; and
l. repeating step a through step k for all lesser-experienced individuals who are enticed by their participation in the current season of study to continue their participation in the next available season of study.

16. The method of claim 15, in which the target continuation percentage is 35%.

17. The method of claim 15, in which at least one of the first-meeting, the next meeting, and the final meeting is held by way of internet-based conferencing that involves two or more individuals of the group of participants.

18. The method of claim 15, in which at least one of the first meeting, the next meeting, and the final meeting is held by way of physical collocation that involves two or more individuals of the group of participants.

19. The method of claim 15, in which:
a. the first-meeting message comprises an indication of a first-assigned content; and
b. the meeting discussion held at the first meeting addresses the first-assigned content.

20. The method of claim 15, in which:
a. the next-meeting message cumulatively comprises:
i. an indication of a next-assigned content; and
ii. at least one prompt related to the meeting discussion held at the first meeting; and
b. the meeting discussion held at the next meeting addresses:
i. a response of each lesser-experienced individual to the prompt; and
ii. the next-assigned content.
